(19) United States
(12) Patent Application Publication
(10) Pub. No.: US 2025/0284155 A1
(43) Pub. Date: Sep. 11, 2025

(54) LIQUID CRYSTAL DISPLAY DEVICE

(71) Applicant: Japan Display Inc., Tokyo (JP)

(72) Inventor: Tenfu NAKAMURA, Tokyo (JP)

(21) Appl. No.: 19/057,039

(22) Filed: Feb. 19, 2025

(30) Foreign Application Priority Data
Mar. 6, 2024 (JP) 2024-033460

(51) Int. Cl. G02F 1/1334; G02F 1/13357; G02F 1/1343

(52) U.S. Cl. CPC G02F 1/1334; G02F 1/133615; G02F 1/134309

(57) ABSTRACT

According to one embodiment, a display device includes a first substrate, a second substrate, a liquid crystal layer, a plurality of light emitting elements, a third transparent substrate, and a transparent layer. The third transparent substrate has, in plan view, a straight portion located on a side of the light emitting elements, and a curved portion. The transparent layer has plurality of strip portions disposed along the first direction and extending along a second direction. The plurality of strip portions each have a first end portion on the light emitting element side and a second end portion opposite to the first end portion, and a width of the first end portion is larger than a width of the second end portion.

### CROSS-REFERENCE TO RELATED APPLICATIONS

This application is based upon and claims the benefit of priority from Japanese Patent Application No. 2024-033460, filed Mar. 6, 2024, the entire contents of which are incorporated herein by reference.

### FIELD

Embodiments described herein relate generally to a display device.

### BACKGROUND

Various display devices using polymer-dispersed liquid crystals that can switch between a scattering state that scatters incident light and a transparent state that transmits incident light have been proposed. In some display devices using polymer-dispersed liquid crystals, the edge-light method, in which a light emitting module is arranged at an edge of the display panel, is used in some cases. Such display devices have high transmittance, and therefore they are expected to be used in various fields. On the other hand, as to the display devices, there is a desire for improving the phenomenon in which the brightness decreases as the location is further apart from the light emitting module.

### BRIEF DESCRIPTION OF THE DRAWINGS

FIG. 1 is a plan view showing a configuration example of a display device DSP according to one embodiment.

FIG. 2 is an exploded perspective view showing a main part of the display device DSP shown in FIG. 1.

FIG. 3 is a cross-sectional view showing a configuration example of the display device DSP shown in FIG. 1.

FIG. 4 is a plan view showing a configuration example of a light guide element LG shown in FIG. 2.

FIG. 5 is a cross-sectional view showing a configuration example of the display device DSP of this embodiment.

FIG. 6 is a plan view showing a light guide element LG′ of a comparative example.

FIG. 7 is a plan view showing another configuration example of the light guide element LG shown in FIG. 2.

FIG. 8 is a plan view showing still another configuration example of the light guide element LG shown in FIG. 2.

FIG. 9 is a plan view showing still another configuration example of the light guide element LG shown in FIG. 2.

FIG. 10 is a plan view showing still another configuration example of the light guide element LG shown in FIG. 2.

### DETAILED DESCRIPTION

In general, according to one embodiment, a display device comprises a first substrate comprising a first transparent substrate and pixel electrodes disposed in each of a plurality of pixels on the first transparent substrate, a second substrate comprising a second transparent substrate, a liquid crystal layer containing strip-like polymers and liquid crystal molecules and disposed between the first substrate and the second substrate. a plurality of light emitting elements arranged along a first direction, a third transparent substrate having a side surface opposing the plurality of light emitting elements, and a transparent layer having a refractive index lower than that of the third transparent substrate and disposed between the second substrate and the third transparent substrate, wherein the third transparent substrate includes, in a plan view, a straight portion located on a side of the plurality of light emitting elements and along the first direction, and a curved portion connected to the straight portion, the transparent layer comprises a plurality of strip portions disposed along the first direction and extending along a second direction that is orthogonal to the first direction, and each of the plurality of strip portions has a first end portion on a side of the plurality of light emitting elements and a second end portion on an opposite side to the first end portion, the first end portion has a width larger than a width of the second end portion, and the plurality of strip portions each have a same width along the first direction at a location of an equal distance from the straight portion along the second direction.

According to the configuration described above, it is possible to provide a display device that can suppress the deterioration of display quality.

Embodiments will be described hereinafter with reference to the accompanying drawings.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

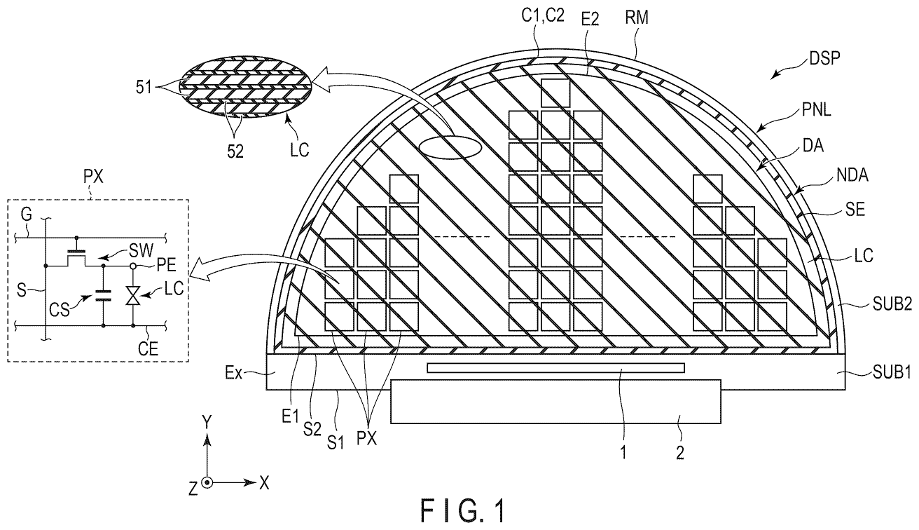

FIG. 1 is a plan view showing a configuration example of a display device DSP of this embodiment. For example, a first direction X, a second direction Y, and a third direction Z are orthogonal to each other, but they may intersect at an angle other than 90 degrees. The first direction X and the second direction Y correspond to directions parallel to a main surface of the substrate that constitutes the display device DSP, and the third direction Z corresponds to the thickness direction of the display device DSP. In this specification, the direction from a first substrate SUB1 towards a second substrate SUB2 is referred to as the “upper side” (or simply “upper” or “above”), and the direction from the second substrate SUB2 towards the first substrate SUB1 is referred to as the “lower side” (or simply “lower” or “below”). With such expressions “a second member above a first member” and “a second member below a first member”, the second member may be in contact with the first member or may be remote from the first member. In addition, it is assumed that there is an observation position to observe the display device DSP on a tip side of an arrow indicating the third direction Z, and viewing from this observation position toward the X-Y plane defined by the first direction X and the second direction Y is referred to as a plan view.

In this embodiment, a liquid crystal display device to which a polymer-dispersed liquid crystal is applied is explained as an example of the display device DSP. The display device DSP comprises a display panel PNL, an IC chip 1, and a wiring substrate 2.

The display panel PNL comprises a first substrate SUB1, a second substrate SUB2, a liquid crystal layer LC, and a seal SE. The first substrate SUB1 and the second substrate SUB2 are formed into a flat plate shape parallel to the X-Y plane. The first substrate SUB1 has a straight portion S1 extending along the first direction X and a curved portion C1 connected to the straight portion S1. The second substrate SUB2 has a straight portion S2 extending along the first direction X and a curved portion C2 connected to the straight portion S2. The curved portion C2 overlaps the curved portion C1 in plan view. The straight portion S2 does not overlap the straight portion S1. The first substrate SUB1 has an extending portion Ex that extends from the straight portion S2 in the second direction Y in plan view.

The first substrate SUB1 and the second substrate SUB2 overlap each other in plan view. The first substrate SUB1 and the second substrate SUB2 are bonded together by the seal SE. The extending portion Ex does not overlap the second substrate SUB2 in plan view. The liquid crystal layer LC is held between the first substrate SUB1 and the second substrate SUB2 and is sealed by the seal SE. In FIG. 1, the liquid crystal layer LC and the seal SE are illustrated by shading lines different from each other.

As schematically shown enlarged in FIG. 1, the liquid crystal layer LC comprises a polymer-dispersed liquid crystal containing polymers 51 and liquid crystal molecules 52. For example, the polymers 51 are liquid crystal polymers. The polymers 51 are formed into a strip shape that extends along the first direction X. The liquid crystal molecules 52 are dispersed in gaps between the polymers 51 and aligned so that their long axes are arranged along the first direction X. Each of the polymers 51 and the liquid crystal molecules 52 has optical anisotropy or refractive index anisotropy. The response of the polymers 51 to an electric field is lower than the response of the liquid crystal molecules 52 to an electric field.

In one example, the orientation of alignment of the polymers 51 does not change substantially regardless of the presence/absence of an electric field. On the other hand, the orientation of alignment of the liquid crystal molecules 52 changes according to the electric field when a high voltage at a threshold or higher is applied to the liquid crystal layer LC. While no voltage is being applied to the liquid crystal layer LC, the optical axes of the polymers 51 and the liquid crystal molecules 52 are parallel to each other, and light entering the liquid crystal layer LC passed therethrough without being substantially scattered in the liquid crystal layer LC (transparent state). When a voltage is being applied to the liquid crystal layer LC, the optical axes of the polymers 51 and the liquid crystal molecules 52 intersect each other, and light entering the liquid crystal layer LC is scattered within the liquid crystal layer LC (scattered state).

The display panel PNL comprises a display area DA for displaying images and a non-display area NDA surrounding the display area DA in a region where the first substrate SUB1 and the second substrate SUB2 overlap each other in plan view. The seal SE is located in the non-display area NDA. In the example illustrated in FIG. 1, the display area DA has an edge portion E1 that is close to the straight portion S2 and extends along the first direction X, and an edge portion E2 that is close to the curved portion C2 and connected to the edge portion E1. The display area DA comprises pixels PX arranged in a matrix along the first direction X and the second direction Y.

As shown enlarged in FIG. 1, each of the pixels PX comprises a switching element SW, a pixel electrode PE, a common electrode CE, a liquid crystal layer LC and the like. The switching element SW is configured, for example, by a thin film transistor (TFT) and is electrically connected to a scanning line G and a signal line S. The scanning line G extends along the first direction X and is electrically connected to the switching element SW of each of the pixels PX arranged along the first direction X. The signal line S extends along the second direction Y, intersects with the scanning line G, and is electrically connected to the switching element SW in each of the pixels PX arranged along the second direction Y. The pixel electrode PE is electrically connected to the switching element SW. Each of the pixel electrodes PE opposes the common electrode CE, and the liquid crystal layer LC (in particular, the liquid crystal molecules 52) is driven by the electric field generated between the pixel electrode PE and the common electrode CE. A capacitance CS is formed, for example, between an electrode having the same potential as that of the common electrode CE and an electrode having the same potential as that of the pixel electrode PE.

The IC chip 1 and the wiring substrate 2 are each connected to the extending portion Ex. The IC chip 1 contains, for example, a display driver built therein that outputs signals necessary for image display, and the like. The wiring substrate 2 is a flexible printed circuit board that can be bent. The IC chip 1 may as well be connected to the wiring substrate 2. The IC chip 1 and the wiring substrate 2 read signals from the display panel PNL in some cases, but they mainly function as signal sources that supply signals to the display panel PNL.

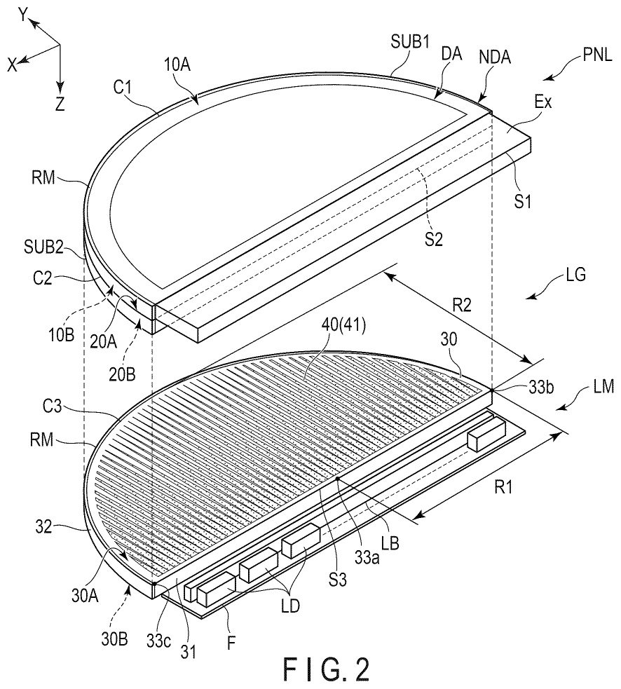

FIG. 2 is an exploded perspective view showing the main part of the display device DSP shown in FIG. 1. In FIG. 2, the side surface of the second substrate SUB2 along the straight portion S2 is shown by dotted lines as transmitted therethrough.

The display device DSP comprises, in addition to the display panel PNL, a light guide element LG and a light emitting module LM. The first substrate SUB1, the second substrate SUB2, and the light guide element LG are arranged in this order along the third direction Z.

The light emitting module LM comprises a plurality of light emitting elements LD, a light guide LB, and a wiring substrate F.

Each of the plurality of light emitting elements LD are arranged at intervals along the first direction X. Each of the light emitting elements LD is connected to the wiring substrate F. In the example illustrated in FIG. 2, each of the light emitting elements LD overlaps the extending portion Ex in plan view. The light emitting elements LD are each a light-emitting diode, for example. Although not described in detail, the light emitting elements LD each comprise a red light emitting portion, a green light emitting portion, and a blue light emitting portion. The light emitted from the light emitting elements LD proceeds in the direction of the arrow indicating the second direction Y. The light guide LB is formed into a rod shape extending along the first direction X, and is disposed between the light emitting element LD and the light guide element LG in the second direction Y.

The light guide element LG comprises a transparent substrate 30 and a transparent layer 40.

The transparent substrate 30 has a straight portion S3 extending along the first direction X and a curved portion C3 connected to the straight portion S3. The straight portion S3 is located on a light emitting element LD side of the transparent substrate 30. The straight portion S3 has one end 33b along the first direction X and another end 33c on an opposite side to the end 33b. The curved portion C3 is connected to the straight portion S3 at the end 33b and the other end 33c. The position equidistant from the end 33b and the other end 33c is referred to as a center 33a of the straight portion S3. In the example illustrated in FIG. 2, a distance R1 defined as from the center 33a of the straight portion S3 to one end 33b of the straight portion S3 and a distance R2 defined as from the center 33a of the straight portion S3 to the curved portion C3 along the second direction Y have lengths equal to each other. Further, in the example illustrated in the figure, the curved portion C3 is formed in an arc shape, and the transparent substrate 30 has a semicircular shape in plan view.

The curved portions C1, C2, and C3 overlap each other in plan view. The straight portions S2 and S3 overlap each other in plan view. The straight portion S3 is located between the straight portion S1 and the display area DA in plan view.

In the example illustrated in FIG. 2, each of the first substrate SUB1, the second substrate SUB2, and the light guide element LG each comprises a reflective member RM disposed on a side surface along the curved portions C1, C2, and C3. The reflective members RM are formed, for example, of a high-reflectivity metal material such as aluminum, silver, or titanium. The reflective members RM each may be a sheet adhered to the respective side surface, or they may be thin films formed directly on the side surfaces by a method such as vapor deposition.

The transparent substrate 30 has a side surface 31 along the straight portion S3. The side surface 31 is a plane that is substantially parallel to the X-Z plane defined by the first direction X and the third direction Z. In plan view, the side surface 31 is located on the light emitting element LD side, and the side surface 31 opposes the plurality of light emitting elements LD via the light guide LB in the second direction Y. Further, the transparent substrate 30 has a side surface 32 along the curved portion C3. The side surface 32 is connected to the side surface 31.

The transparent layer 40 is disposed between the transparent substrate 30 and the second substrate SUB2. In the example illustrated in the figure, the transparent layer 40 is formed on the surface of the transparent substrate 30, which opposes the second substrate SUB2. Note that the transparent layer 40 may as well be formed on the surface of the second substrate SUB2, which opposes the transparent substrate 30. The transparent layer 40 comprises a plurality of strip portions 41 arranged along the first direction X. Each of the strip portions 41 extends along the second direction Y and is formed into an approximately isosceles triangular shape.

When the display panel PNL and the light guide element LG shown in FIG. 2 overlap each other, the plurality of strip portions 41 overlap the display area DA in plan view.

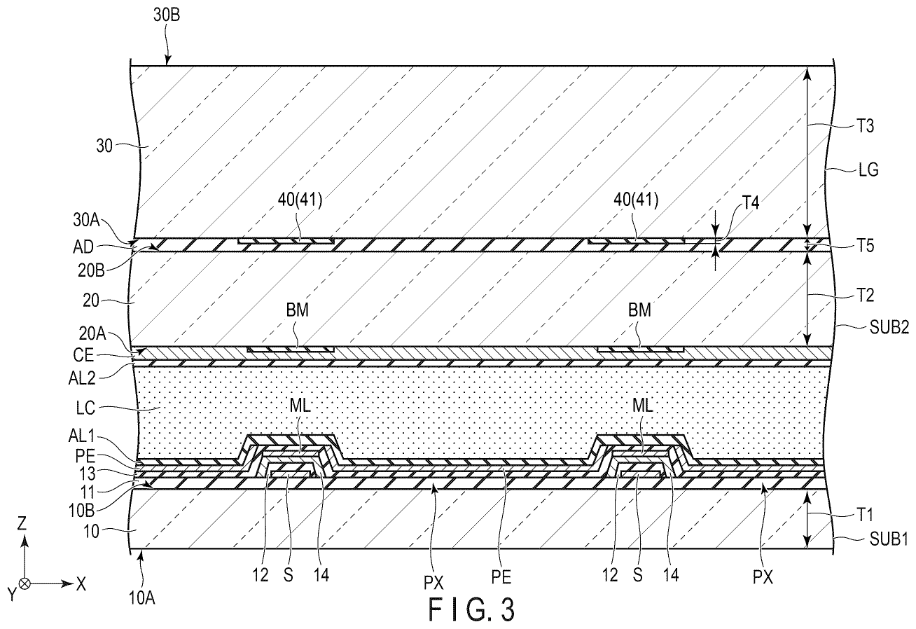

FIG. 3 is a cross-sectional view showing a configuration example of the display device DSP shown in FIG. 1. Here, the cross-section of the display area DA in the X-Z plane defined by the first direction X and the third direction Z will be explained.

The first substrate SUB1 comprises a transparent substrate 10, insulating films 11, 12 and 13, capacitive electrodes 14, metal wiring lines ML, signal lines S, pixel electrodes PE, and an alignment film AL1. The first substrate SUB1 further comprises switching elements SW and scanning lines G shown in FIG. 1. The scanning lines G are each disposed between the transparent substrate 10 and the insulating film 11, for example.

The transparent substrate 10 comprises a main surface (lower surface) 10A and a main surface (upper surface) 10B on an opposite side to the main surface 10A. The main surfaces 10A and 10B are surfaces that are substantially parallel to the X-Y plane. The insulating film 11 covers the main surface 10B. The signal lines S are disposed above the insulating film 11.

The insulation film 12 covers the signal lines S. Although not described in detail, the insulation film 12 is formed in a lattice pattern that overlaps the scanning lines G and the signal lines S. The capacitive electrodes 14 are disposed on the insulation film 12. The metal wiring lines ML are disposed on the capacitive electrodes 14. Although not described in detail, the capacitive electrodes 14 and the metal wiring lines ML are formed in a lattice pattern that overlaps the insulation film 12.

The insulating film 13 covers the insulating film 11, the capacitive electrodes 14 and the metal wiring lines ML. Each of the pixel electrode PE is provided for each respective pixel PX above the insulating film 13. The pixel electrodes PE are electrically connected to the switching elements SW, respectively. The pixel electrodes PE oppose the capacitive electrodes 14 via the insulating film 13, and form the capacitance CS of the pixels PX. The alignment film AL1 covers the pixel electrodes PE and the insulating film 13.

The second substrate SUB2 comprises a transparent substrate 20, light shielding layers BM, a common electrode CE, and an alignment film AL2.

The transparent substrate 20 comprises a main surface (lower surface) 20A and a main surface (upper surface) 20B on an opposite side to the main surface 20A. The main surfaces 20A and 20B are surfaces that are substantially parallel to the X-Y plane. The main surface 20A of the transparent substrate 20 opposes the main surface 10B of the transparent substrate 10.

The light shielding layers BM and the common electrode CE are disposed on the main surface 20A. The light shielding layers BM are each located, for example, directly above the signal lines S and directly above the switching elements SW and the scanning lines G, which are not shown in the figure. The common electrode CE is provided over multiple pixels PX, and in the third direction Z, it opposes each of the pixel electrodes PE via the liquid crystal layer LC, and directly covers the light shielding layers BM. The common electrode CE is electrically connected to the capacitive electrodes 14 and has the same potential as that of the capacitive electrodes 14.

The alignment film AL2 covers the common electrode CE. The liquid crystal layer LC is located between the main surface 10B and the main surface 20A and is in contact with the alignment films AL1 and AL2.

On the first substrate SUB1, the insulating films 11, 12 and 13, the capacitive electrodes 14, the signal lines S, the pixel electrodes PE, and the alignment film AL1 are located between the main surface 10B and the liquid crystal layer LC. On the second substrate SUB2, the light shielding layers BM, the common electrode CE, and the alignment film AL2 are located between the main surface 20A and the liquid crystal layer LC.

The transparent substrates 10 and 20 are insulating substrates such as glass substrates or plastic substrates. The insulating film 11 is an inorganic insulating film formed of silicon oxide, silicon nitride, silicon oxynitride or the like. The insulating film 12 is, for example, an organic insulating film formed of acrylic resin or the like. The insulating film 13 is an inorganic insulating film formed of silicon nitride.

The capacitive electrodes 14, the pixel electrodes PE, and the common electrode CE are transparent electrodes formed from a transparent conductive material such as indium tin oxide (ITO), indium zinc oxide (IZO) or the like. The light shielding layers BM may be conductive layers or insulating layers.

The alignment films AL1 and AL2 are horizontal alignment films that have an alignment restriction force that is substantially parallel to the X-Y plane. In one example, the alignment films AL1 and AL2 are subjected to an alignment treatment along the first direction X. Note that the alignment treatment may be a rubbing treatment or an optical alignment treatment.

The light guide element LG comprises a transparent substrate 30 and a transparent layer 40.

The transparent substrate 30 is an insulating substrate having a refractive index n1. The transparent substrate 30 is, for example, a glass substrate, but it may as well be a plastic substrate formed of polymethyl methacrylate (PMMA) or polycarbonate (PC). In one example, the transparent substrate 30 is a single substrate, not a composite of multiple substrates attached together. The transparent substrate 30 has a main surface (lower surface) 30A and a main surface (upper surface) 30B on an opposite side to the main surface 30A. The main surfaces 30A and 30B are surfaces that are substantially parallel to the X-Y plane. The main surface 30A opposes the main surface 20B of the transparent substrate 20.

The transparent layer 40 is disposed on the main surface 30A. The transparent layer 40 is formed, for example, from an organic material such as a siloxane-based resin, a fluorine-based resin or the like. The transparent layer 40 comprises a plurality of strip portions 41 arranged along the first direction X. Each of the strip portions 41 extends along the second direction Y. The main surface 30A is exposed between each adjacent pair of the strip portions 41. In the example illustrated in FIG. 3, the strip portions 41 are located above the respective signal lines S so as to overlap in plan view. The shape of the transparent layer 40 will be described in detail later.

In the example illustrated in FIG. 3, the transparent substrate 30 is adhered to the transparent substrate 20 of the second substrate SUB2 by a transparent adhesive layer AD. The transparent adhesive layer AD is brought into contact with the main surface 20B substantially in its entirety, and covers the transparent layer 40. In the region where the transparent layer 40 is absent, the layer AD is brought into contact with the main surface 30A.

The transparent substrate 10 has a thickness T1, the transparent substrate 20 has a thickness T2, the transparent substrate 30 has a thickness T3, the transparent layer 40 has a thickness T4, and the transparent adhesive layer AD has a thickness T5. In this specification, the thickness corresponds to the length taken along the third direction Z.

In the example illustrated in the figure, the thickness T1 is equivalent to the thickness T2, and the thickness T3 is greater than the thickness T1 or T2. Note that the thickness T3 may be equal to the thickness T1 and the thickness T2. In one example, the thickness T3 is 200 μm to 2000 μm. The thickness T4 of the transparent layer 40 is less than or equal to the maximum wavelength of the light L1 emitted from the light emitting element LD, which will be described later. In one example, the thickness T4 is 250 nm to 1500 nm. The thickness T5 of the transparent adhesive layer AD is 4 μm to 4000 μm.

The transparent layer 40 has a refractive index n2 that is smaller than the refractive index n1 of the transparent substrate 30. The refractive index n1 of the transparent substrate 30 is about 1.5, and the refractive index n2 of the transparent layer 40 is about 1.0 to 1.4. The refractive index of each of the transparent substrates 10 and 20, and the transparent adhesive layer AD is equivalent to the refractive index n1 of the transparent substrate 30, and is higher than the refractive index n2 of the transparent layer 40. Note that the expression “equivalent” used here does not only mean when the difference in refractive index is zero, but also includes such cases where the difference in refractive index is 0.03 or less.

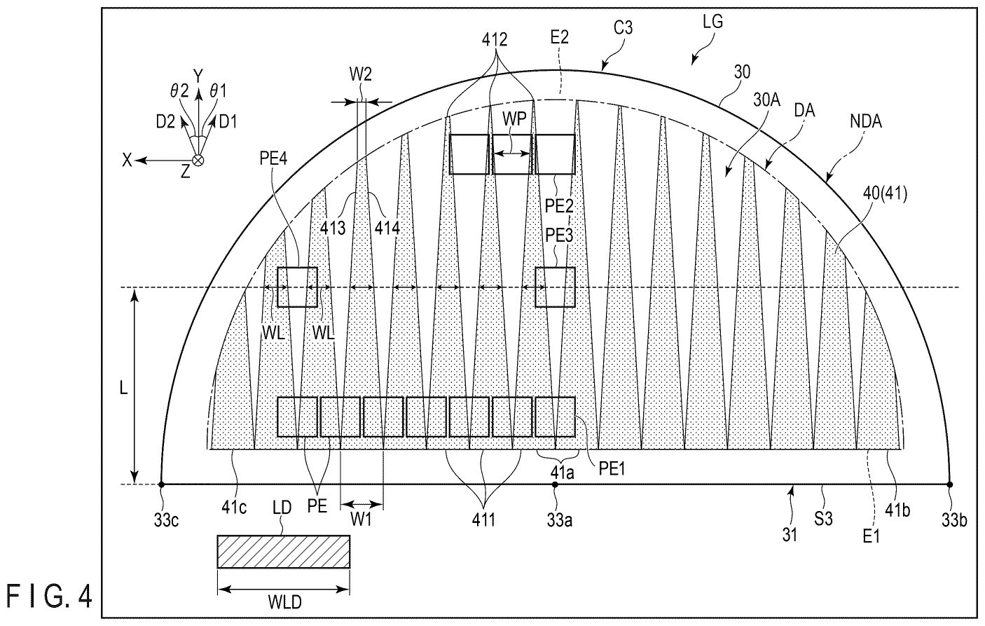

FIG. 4 is a plan view showing a configuration example of the light guide element LG shown in FIG. 3. FIG. 4 schematically shows the strip portion 41 in its width enlarged view along the first direction X. Further, in FIG. 4, the area that overlaps the display area DA when the light guide element LG is overlaid on the display panel PNL shown in FIG. 2 is indicated by an alternate long and short dash line.

The strip portion 41 comprises a first end portion 411 on a light emitting element LD side, a second end portion 412 on an opposite side to the first end portion 411, a first edge 413, and a second edge 414. The strip portions 41 are arranged along the first direction X. The first end portions 411 are arranged on the same straight line along the first direction X.

With regard to the length of each of the strip portions 41 along the second direction Y, the length of a strip portion 41a extending from the vicinity of the center 33a of the straight portion S3 along the second direction Y takes the maximum value, and the length of each of a strip portions 41b extending from the vicinity of one end 33b of the straight portion S3 along the second direction Y and a strip portion 41c extending from the vicinity of the other end 33c of the straight portion S3 along the second direction Y takes the minimum value. Further, between from the strip portion 41a to the strip portion 41b, the length of the strip portion 41 gradually becomes shorter, and similarly, the length of the strip portion 41 gradually becomes shorter between from the strip portion 41a to the strip portion 41c.

In the example illustrated in FIG. 4, each of the first end portions 411 overlaps the edge portion E1 of the display area DA in plan view, and each of the second end portions 412 overlaps the edge portion E2 of the display area DA in plan view, but the configuration is not limited to this. From the perspective of suppressing light leakage between the straight portion S3 and the display area DA, it is desirable that each of the first end portions 411 is in close proximity to the straight portion S3 over the display area DA.

The first end portions 411 and the second end portions 412 have a first width W1 and a second width W2, respectively. Note that the term “width” used in this specification corresponds to the length taken along the first direction X. The first width W1 is greater than the second width W2. In one example, the first width W1 is less than a width WLD of a single light emitting element LD, and each single light emitting element LD is disposed over across multiple strip portions 41 aligned along the first direction X. Further, the first width W1 is equal to or less than the width WP (or the pitch of the pixel electrodes PE aligned in the first direction X) of each single pixel electrode PE.

The first width W1 is substantially the same for all the strip portions 41. On the other hand, the second width W2 of the strip portion 41a is less than the second width W2 of each of the strip portions 41b and 41c.

The first edge 413 and the second edge 414 each extend between the first end portion 411 and the second end portion 412 along a direction different from the first direction X and the second direction Y. For example, the direction that intersects at an acute angle clockwise relative to the second direction Y is defined as a direction D1, and the direction that intersects at an acute angle counterclockwise relative to the second direction Y is defined as a direction D2. Note that an angle θ1 made between the second direction Y and the direction D1, and an angle θ2 made between the second direction Y and the direction D2 are the same as each other, but the configuration is not limited to this. Note that the angle made between the second direction Y and the direction D1 and the angle made between the second direction Y and the direction D2 may be different from each other.

The first edge 413 extends along the direction D1, and the second edge 414 extends along the direction D2. Here, the first edge 413 and the second edge 414 are both to extend in a straight line, but they may as well be formed into a curved shape. The first width W1 and the second width W2 correspond to the distance between the first edge 413 and the second edge 414 taken along the first direction X.

The strip portion 41 of such a shape has a width that gradually decreases at a constant rate or at an arbitrary rate as the location approaches from the first end portion 411 towards the second end portion 412. Each of the strip portions 41 has the same width WL along the first direction X at a location, which is at an equal distance L along the second direction Y from the straight portion S3. The location of the equal distance L is a location on a side of the curved portion C3 with respect to first end portion 411, and the distance L is, for example, about ¼ to ½ of the distance R2 shown in FIG. 2. The pitch of each adjacent pair of the strip portions 41 should desirably be twice or less than the width WP of the pixel electrode PE (or the pitch of the pixel electrodes PE arranged along the first direction X).

In plan view, the pixel electrode PE overlaps two adjacent strip portions 41. The pixel electrode PE overlaps the main surface 30A of the transparent substrate 30 between each adjacent pair of the strip portions 41.

In the display area DA, the pixel electrode PE1 that is closest to the light emitting element LD and the pixel electrode PE2 that is furthest from the light emitting element LD will now be focused. The area of the region where the pixel electrode PE1 overlaps the transparent layer 40 is greater than the area of the region where the pixel electrode PE2 overlaps the transparent layer 40. In other words, the area of the region where the main surface 30A and the pixel electrode PE1 overlap each other without interposing the transparent layer 40 therebetween is less than the region of the area where the main surface 30A and the pixel electrode PE2 overlap each other without interposing the transparent layer 40 therebetween. As described above, in the region close to the light emitting element LD, the overlapping area between the pixel electrode PE and the transparent layer 40 is larger as compared to the region distant from the light emitting element LD.

Further, in the display area DA, of the pixel electrodes PE that are located a distance L away from the straight portion S3 in the second direction Y, the pixel electrode PE3 that is located at the center along the first direction X and the pixel electrode PE4 that is located at the end along the first direction X will be focused. The area of the region where the pixel electrode PE3 overlaps the transparent layer 40 is equivalent to the area of the region where the pixel electrode PE4 overlaps the transparent layer 40. Further, the area of the region where the pixel electrode PE3 overlaps the main surface 30A is equivalent to the area of the region where the pixel electrode PE4 overlaps the main surface 30A.

As will be explained later, the region that overlaps the transparent layer 40 corresponds to the region where substantially no light from the light emitting element LD enters the display panel PNL, and the region that overlaps the main surface 30A without interposing the transparent layer 40 therebetween corresponds to the region where light from the light emitting element LD can enter the display panel PNL.

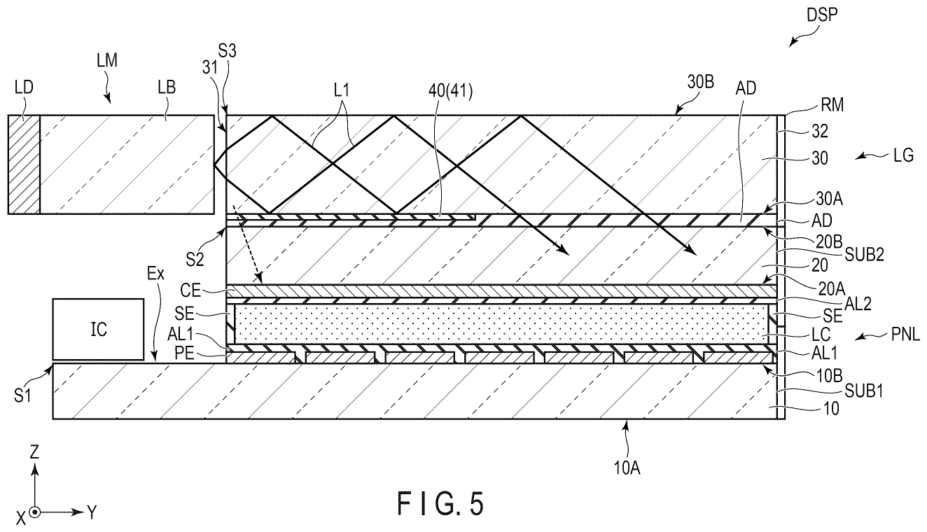

FIG. 5 is a cross-sectional view showing a configuration example of the display device DSP shown in FIG. 1. Note that only the main part of the display panel PNL is shown in the figure. With reference to FIG. 5, emission light from the light emitting element LD will be explained.

The light emitting element LD emits light L1 towards a side surface 31. The light L1 emitted from the light emitting element LD passes through the light guide LB, and then is refracted at the side surface 31 and enters the transparent substrate 30. Of the light L1 entering the transparent substrate 30, part of the light that proceeds from the transparent substrate 30 towards the transparent layer 40 is reflected at the interface between the transparent substrate 30 and the transparent layer 40, and does not reach the second substrate SUB2, the liquid crystal layer LC, or the first substrate SUB1. Further, of the light proceeding from the transparent substrate 30 towards the transparent layer 40, the light with an incident angle smaller than the critical angle passes through the transparent layer 40 and reaches the liquid crystal layer LC, as shown by the dotted line.

Further, of the light L1 that enters the transparent substrate 30, the light that proceeds towards the main surface 30B is reflected at the interface between the transparent substrate 30 and the air layer. As described above, most of the light L1 proceeds through inside the transparent substrate 30 while being repeatedly reflected in the vicinity of the side surface 31 (or in the region where the transparent layer 40 exists). Of the proceeding light L1, the light that is proceeding towards the region where the transparent layer 40 does not exist, that is, the region where the transparent substrate 30 and the transparent adhesive layer AD are brought into contact with each other, passes through the transparent substrate 30 and then passes through the transparent substrate 20 via the transparent adhesive layer AD.

In the liquid crystal layer LC of the pixel to which voltage is being applied, the light L1 is scattered. Further, in the liquid crystal layer LC of the pixel to which no voltage is being applied, the light L1 passes through.

As shown in the example in FIG. 5, when a reflective member RM is provided on an opposite side to the light emitting element LD, for example, the light L1 that has reached the side surface 32 is reflected toward the display area by the reflective member RM. With this configuration, the light leakage from the side surface 32 can be prevented, thereby making it possible to improve the utilization efficiency of light L1 compared to the case where a reflective member RM is not provided.

As explained with reference to FIG. 4, in the region close to the light emitting element LD, the overlapping area between the pixel electrode PE and the strip portion 41 is greater than that of the region distant from the light emitting element LD. With this structure, in the region close to the light emitting element LD, the entering of the light L1 into the pixel electrode PE is suppressed, whereas in the region distant from the light emitting element LD, the entering of the light L1 into the pixel electrode PE is promoted. Note that in the region close to the light emitting element LD, it is not that light L1 does not enter the display panel PNL at all, but as shown in FIG. 4, light L1 enters the display panel PNL through the gap in each adjacent pair of the strip portions 41, and light with an incident angle that deviates from the total reflection condition enters the display panel PNL. In the regions that are distant by the same distance L away from the light emitting element LD, the areas of the regions where the pixel electrode PE and the transparent layer 40 overlap each other are the same as each other. Therefore, in the regions that are distant by the same distance L away from the light emitting element LD, the light L1 enters each of the pixel electrodes PE at the same degree.

Of the light entering the liquid crystal layer LC, the light that is proceeding towards the transparent layer 40 is reflected at the interface between the transparent substrate 30 and the transparent layer 40. The light L1 entering the liquid crystal layer LC passes through the pixels in a transparent state, whereas it is scattered at the pixels in the scattered state. The display device DSP can be observed from the main surface 10A side as well as from the main surface 30B side. Further, the display device DSP is a so-called transparent display, and even when observed from the main surface 10A side or the main surface 30B side, the background of the display device DSP can be observed through the display device DSP.

According to this embodiment, it is possible to suppress the non-uniformity of the brightness of the display panel PNL.

When focusing on the brightness distribution of the light L1 from the light emitting element LD, the brightness tends to decrease in the region that is distant from the light emitting element LD. One of the causes of the decrease in brightness is the undesired absorption and scattering of the light L1 by the liquid crystal layer LC, signal lines S, various insulating films and the like.

Further, in a display device DSP having a shape different from a rectangle, the distance from the side surface 31 where the light L1 enters the transparent substrate 30 to the side surface 32 connected to the side surface 31 is not constant. In areas where the distance from the side surface 31 to the side surface 32 along the second direction Y is relatively long, the brightness of the display panel PNL tends to be lower than as compared to the areas where the distance is relatively short when the light L1 is irradiated from each of the light emitting elements LD at the same intensity. Thus, there is a risk that the brightness of the display panel PNL becomes uneven in such a display device DSP having a shape different from a rectangle.

The region where the transparent layer 40 overlaps the pixel electrode PE corresponds to the region where substantially no light L1 from the light emitting element LD enters the display panel PNL, and the region where the transparent layer 40 does not overlap the pixel electrode PE (or the region between each adjacent pair of the strip portions 41) corresponds to the region where the light L1 from the light emitting element LD enters the display panel PNL.

In the region close to the light emitting element LD, the overlapping area of the transparent layer 40 per single pixel electrode PE is greater than as compared to region distant away from the light emitting element LD. Therefore, in the region close to the light emitting element LD, the entering of the light L1 into the display panel PNL is suppressed, and the absorption and scattering of the light L1 by the liquid crystal layer LC, signal lines S, various insulating films and the like is suppressed. On the other hand, in the region distant from the light emitting element LD, the entering of the light L1 into the display panel PNL is promoted. As described above, the light from the light emitting element LD attenuates as the location becomes more distant from the light emitting element LD. The overlapping area between the pixel electrode PE1 and the transparent layer 40 shown in FIG. 4 is greater than the overlapping area between the pixel electrode PE2 and the transparent layer 40. Therefore, the area of the region where the light L1 can enter the pixel electrode PE1 is less than the area of the region where the light L1 can enter the pixel electrode PE2. On the other hand, the intensity of the light entering the pixel electrode PE1 is stronger than the intensity of the light entering the pixel electrode PE2. Therefore, the brightnesses of the display panel PNL in the pixel electrode PE1 and the pixel electrode PE2 can be made equal to each other.

The overlapping area between the pixel electrode PE3 and the transparent layer 40 shown in FIG. 4 is equivalent to the overlapping area between the pixel electrode PE4 and the transparent layer 40. Further, the intensity of the light L1 entering the pixel electrode PE3 is equivalent to the intensity of the light L1 entering the pixel electrode PE4. Therefore, the brightnesses of the display panel PNL in the pixel electrode PE3 and the pixel electrode PE4 can be made equal to each other.

As described above, according to this embodiment, even in a display device having a shape different from a rectangle, it is possible to suppress the non-uniformity of the brightness of the display panel PNL. Therefore, the deterioration of the display quality of the image displayed on the display panel PNL can be suppresses.

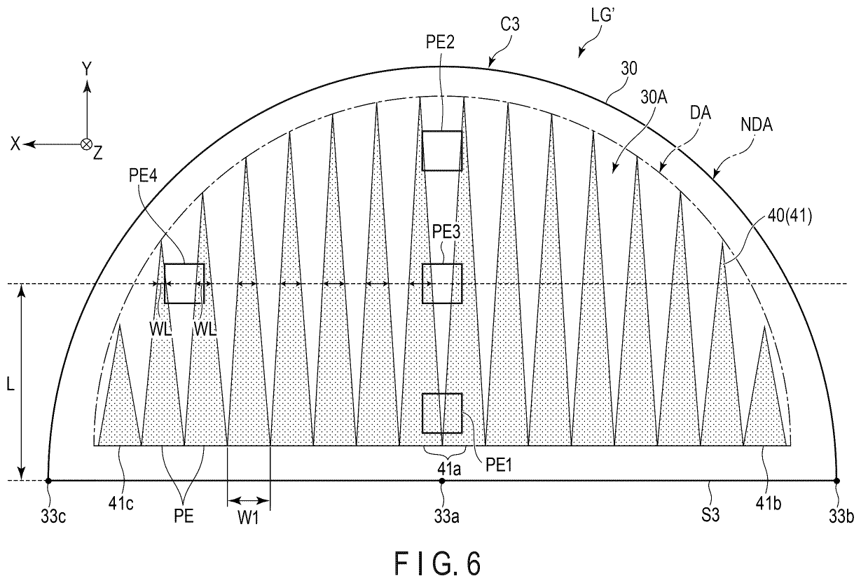

FIG. 6 is a plan view showing a light guide element LG′ of a comparative example. The light guide element LG′ of the comparative example is different as compared to the light guide element LG in that each of the strip portions 41 does not have the same width along the first direction X at a position, which is distant by an equal distance L from the straight portion S3 along the second direction Y.

In the comparative example illustrated in FIG. 6, each of the strip portions 41 has an isosceles triangular shape elongated along the second direction Y. In the comparative example illustrated in FIG. 6, with respect to the width WL of the strip portion 41 along the first direction X taken at a position of the equal distance L from the straight portion S3 along the second direction Y, the length of the strip portion 41a extending along the second direction Y from the vicinity of the center 33a of the straight portion S3 is at the maximum, and the length of the strip portion 41b extending along the second direction Y from the vicinity of one end 33b of the straight portion S3 and the length of the strip portion 41c extending along the second direction Y from the vicinity of the other end 33c are at the minimum. Between from the strip portion 41a to the strip portion 41b, the width WL gradually decreases, and similarly, the width WL gradually decreases between from the strip portion 41a to the strip portion 41c as well.

In the comparative example illustrated in FIG. 6, of the pixel electrodes PE that are located distant by a distance L from the straight portion S3 along the second direction Y, the pixel electrode PE3, which is located in the center along the first direction X, and the pixel electrode PE4, which is located at the edge along the first direction X are focused. The area of the region where the pixel electrode PE3 overlaps the transparent layer 40 is greater than the area of the region where the pixel electrode PE4 overlaps the transparent layer 40. Therefore, the area of the region where the light L1 can enter the pixel electrode PE3 is less than the area of the region where the light L1 can enter the pixel electrode PE4. On the other hand, as described above, the intensity of the light L1 entering the pixel electrode PE3 is equivalent to the intensity of the light L1 entering the pixel electrode PE4. With this configuration, the brightness of the pixel electrode PE3 becomes lower than that of the pixel electrode PE4, and therefore it is not possible to equalize the brightness of the display panel PNL between the pixel electrode PE3 and the pixel electrode PE4.

As shown in the comparative example in FIG. 6, in a light guide element LG′ in which each of the strip portions 41 does not have the same width WL along the first direction X at a location which is at an equal distance L from the straight portion S3 along the second direction Y, it is not possible to suppress the non-uniformity of the brightness of the display panel PNL, and the deterioration of the display quality of images displayed on the display panel PNL cannot be suppressed.

Next, other configuration examples of the present embodiment will be explained.

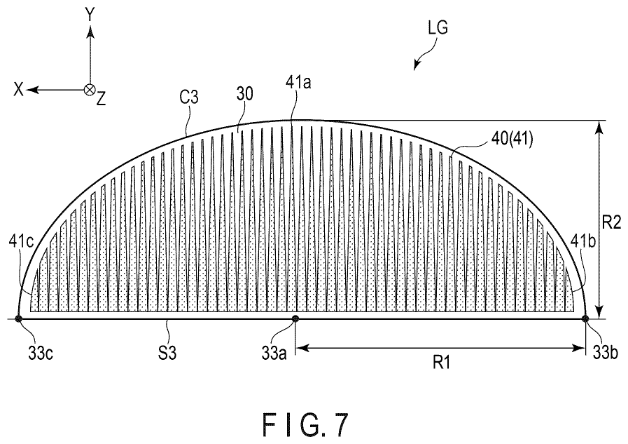

FIG. 7 is a plan view showing another configuration example of the light guide element LG shown in FIG. 2. The example illustrated in FIG. 7 is different from the example illustrated in FIG. 2 in that the distance R2 along the second direction Y from the center 33a of the straight portion S3 to the curved portion C3 differs from the distance R1 from one end 33b of the straight portion S3 to the center 33a. The distance R1 from the center 33a of the straight portion S3 to one end 33b of the straight portion S3 is longer than the distance R2 along the second direction Y from the center 33a of the straight portion S3 to the curved line C3. The transparent substrate 30 has a substantially semicircular shape in plan view. The strip portions 41 are arranged along the first direction X.

With regard to the length of each of the strip portions 41 along the second direction Y, the length of the strip portion 41a extending along the second direction Y from the vicinity of the center 33a of the straight portion S3 is at the maximum, and the length of the strip portion 41b extending along the second direction Y from the vicinity of one end 33b of the straight portion S3 and the length of the strip portion 41c extending along the second direction Y from the vicinity of the other end 33c of the straight portion S3 are each at the minimum. Further, between from the strip portion 41a to the strip portion 41b, the length of the strip portion 41 gradually decreases, and similarly, the length of the strip portion 41 gradually decreases between from the strip portion 41a to the strip portion 41c as well. Each of the strip portions 41 has the same width WL along the first direction X at a location which is distant by an equal distance L along the second direction Y from the straight portion S3.

In this configuration example as well, advantageous effects similar to those of the configuration example illustrated in FIG. 2 can be obtained.

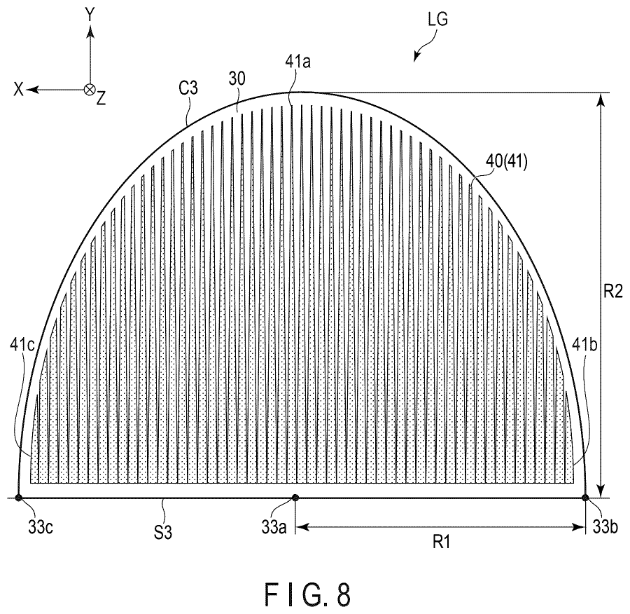

FIG. 8 is a plan view showing another configuration example of the light guide element LG shown in FIG. 2. The configuration example illustrated in FIG. 8 is different from the configuration example illustrated in FIG. 2 in that the distance R2 along the second direction Y from the center 33a of the straight portion S3 to the curved portion C3 differs from the distance R1 from one end 33b of the straight portion S3 to the center 33a. The distance R1 from the center 33a of the straight portion S3 to one end 33b of the straight portion S3 is shorter than the distance R2 along the second direction Y from the center 33a of the straight portion S3 to the curved portion C3. The transparent substrate 30 has a substantially semicircular shape in plan view. The strip portions 41 are arranged along the first direction X.

With respect to the length of each of the strip portions 41 along the second direction Y, the length of the strip portion 41a extending along the second direction Y from the vicinity of the center 33a of the straight portion S3 is at the maximum, and the length of the strip portion 41b extending along the second direction Y from the vicinity of one end 33b of the straight portion S3 and the length of the strip portion 41c extending along the second direction Y from the other end 33c of the straight portion S3 are each at the minimum. Further, between from the strip portion 41a to the strip portion 41b, the length of the strip portion 41 gradually decreases, and similarly, the length of the strip portion 41 gradually decreases between from the strip portion 41a to the strip portion 41c. Each of the strip portions 41 has the same width WL along the first direction X at a position which is distant by an equal distance L along the second direction Y from the straight portion S3.

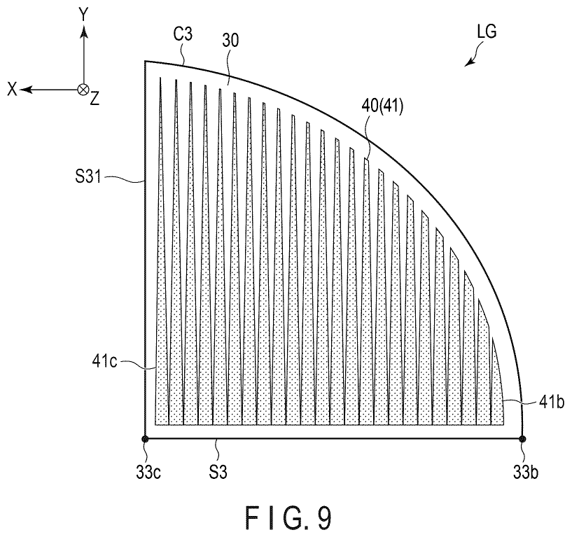

FIG. 9 is a plan view showing still another configuration example of the light guide element LG shown in FIG. 2. The configuration example illustrated in FIG. 9 is different from the configuration example illustrated in FIG. 2 in that the transparent substrate 30 has a straight portion S3 extending along the first direction X, a straight portion S31 extending along the second direction Y, and a curved portion C3 connecting the straight portion S3 and the straight portion S31 to each other. The straight portion S3 has one end 33b connected to the curved portion C3 and another end 33c connected to the straight portion S31. The transparent substrate 30 has a fan shape in plan view. The strip portions 41 are arranged along the first direction X.

With regard to the length of each of the strip portions 41 along the second direction Y, the length of the strip portion 41b extending along the second direction Y from the vicinity of one end 33b of the straight portion S3 is at the minimum, and the length of the strip portion 41c extending along the second direction Y from the vicinity of the other end 33c of the straight portion S3 is at the maximum. Further, between from the strip portion 41b to the strip portion 41c, the length of the strip portion 41 gradually increases. Each of the strip portions 41 has the same width WL along the first direction X at a location which is distant by an equal distance L along the second direction Y from the straight portion S3.

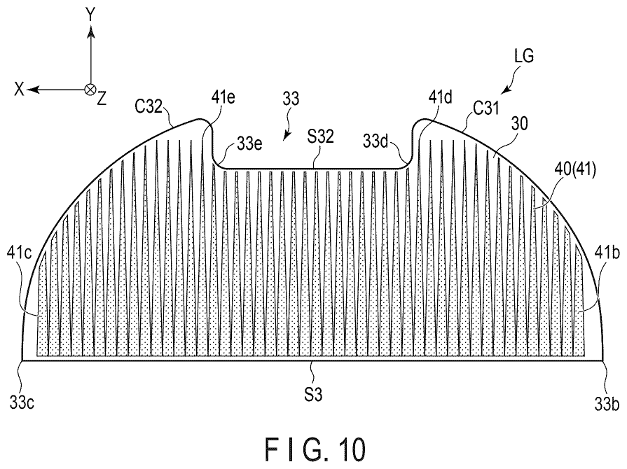

FIG. 10 is a plan view showing still another configuration example of the light guide element LG shown in FIG. 2. The configuration example illustrated in FIG. 10 is different from the configuration example illustrated in FIG. 2 in that the transparent substrate 30 has a notch 33 located on an opposite side to the straight portion S3. In the example illustrated, the notch 33 is located between the curved portion C31 connected to one end 33b side of the straight portion S3, and the curved portion C32 connected to the other end 33c side of the straight portion S3. The notch 33 includes a straight portion S32 along the first direction X.

With regard to the length of each of the strip portions 41 along the second direction Y, the lengths of the strip portions 41 that extend towards the straight portion S32 are each substantially constant and are substantially equal to each other. The length of the strip portion 41d adjacent to one end 33d of the straight portion S32, which extends towards the curved portion C31, and the length of the strip portion 41e adjacent to the other end 33e of the straight portion S32, that extends towards the curved portion C32 are each at the maximum. The length of the strip portion 41b extending from the vicinity of one end 33b of the straight portion S3 and the length of the strip portion 41c extending from the vicinity of the other end 33c of the straight portion S3 are each at the minimum. The length of the strip portion 41 gradually becomes shorter as the location approaches from the strip portion 41d to the strip portion 41b. The length of the strip portion 41 gradually becomes shorter as the location approaches from the strip portion 41e to the strip portion 41c. Each of the strip portions 41 has the same width WL along the first direction X at a location which is distant by an equal distance L along the second direction Y from the straight portion S3.

In this configuration example as well, advantageous effects similar to those of the configuration example illustrated in FIG. 2 can be obtained.

As explained above, according to this embodiment, it is possible to provide a display device that can suppress the deterioration of display quality.

In this embodiment, for example, the transparent substrate 10 corresponds to the first transparent substrate, the transparent substrate 20 corresponds to the second transparent substrate, the transparent substrate 30 corresponds to the third transparent substrate, the pixel electrode PE1 corresponds to the first pixel electrode, the pixel electrode PE2 corresponds to the second pixel electrode, the pixel electrode PE3 corresponds to the third pixel electrode, and the pixel electrode PE4 corresponds to the fourth pixel electrode.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate comprising a first transparent substrate and pixel electrodes disposed in each of a plurality of pixels on the first transparent substrate;
a second substrate comprising a second transparent substrate;
a liquid crystal layer containing strip-like polymers and liquid crystal molecules and disposed between the first substrate and the second substrate;
a plurality of light emitting elements arranged along a first direction;
a third transparent substrate having a side surface opposing the plurality of light emitting elements; and
a transparent layer having a refractive index lower than that of the third transparent substrate and disposed between the second substrate and the third transparent substrate,
wherein
the third transparent substrate includes, in plan view,
a straight portion located on a side of the plurality of light emitting elements and along the first direction, and
a curved portion connected to the straight portion,
the transparent layer comprises a plurality of strip portions disposed along the first direction and extending along a second direction that is orthogonal to the first direction, and
each of the plurality of strip portions has a first end portion on a side of the plurality of light emitting elements and a second end portion on an opposite side to the first end portion,
the first end portion has a width larger than a width of the second end portion, and
the plurality of strip portions each have a same width along the first direction at a location of an equal distance from the straight portion along the second direction.

2. The display device of claim 1, wherein
each of the first transparent substrate and the second transparent substrate has a curved portion that overlaps the curved portion of the third transparent substrate in plan view.

3. The display device of claim 2, wherein
the second transparent substrate has a straight portion that overlaps the straight portion of the third transparent substrate in plan view,
the first transparent substrate has an extending portion that extends from the straight portion of the second transparent substrate along the second direction in plan view, and
the light emitting element overlaps the extending portion in plan view.

4. The display device of claim 2, further comprising:
a reflective member disposed on a side surface along each the curved portion of the first substrate, the second substrate, and the third transparent substrate.

5. The display device of claim 1, wherein
the first end portion of each of the plurality of strip portions is arranged on a same straight line along the first direction.

6. The display device of claim 1, wherein
a length along the second direction from a center of the straight portion to the curved portion is equal to a length from an end portion of the straight portion to the center.

7. The display device of claim 6, wherein
the curved portion is formed into an arc shape.

8. The display device of claim 5, wherein
a length along the second direction of each of the plurality of strip portions increases as a location approaches from an end portion of the straight portion towards a center of the straight portion.

9. The display device of claim 1, wherein
a length along the second direction from a center of the straight portion to the curved portion is different from a length from an end portion of the straight portion to the center.

10. The display device of claim 9, wherein
the length along the second direction from the center of the straight portion to the curved portion is shorter than the length from the end portion of the straight portion to the center.

11. The display device of claim 9, wherein
the length along the second direction from the center of the straight portion to the curved portion is longer than the length from the end portion of the straight portion to the center.

12. The display device of claim 1, wherein
the third transparent substrate has a notch located on an opposite side to the straight portion along the second direction.

13. The display device of claim 12, wherein
of the plurality of strip portions, lengths of the strip portions which extend toward the notch along the second direction are substantially equal to each other.

14. The display device of claim 1, wherein
the first substrate further comprises a scanning line, a signal line that intersects the scanning line, and a switching element electrically connected to the scanning line and the signal line, and
each of the plurality of strip portions overlaps the signal line.

15. The display device of claim 1, wherein
the pixel electrodes include a first pixel electrode and a second pixel electrode arranged along the second direction,
the second pixel electrode is closer to the curved portion than the first pixel electrode, and
an area of the first pixel electrode that overlaps the transparent layer is larger than an area of the second pixel electrode that overlaps the transparent layer.

16. The display device of claim 1, wherein
the pixel electrodes include a third pixel electrode and a fourth pixel electrode arranged at a location at equal distances from the straight portion along the second direction and aligned along the first direction,
the third pixel electrode is located in a center portion along the first direction,
the fourth pixel electrode is closer to the curved portion than the third pixel electrode, and
an area of the third pixel electrode that overlaps the transparent layer is equal to an area of the fourth pixel electrode that overlaps the transparent layer.
